(19) United States
(12) Patent Application Publication
(10) Pub. No.: US 2006/0238493 A1
(43) Pub. Date: Oct. 26, 2006

(54) System and method to activate a graphical user interface (GUI) via a laser beam

(76) Inventor: Randy R. Dunton, Phoenix, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/112,653

(22) Filed: Apr. 22, 2005

(51) Int. Cl. G09G 5/00

(52) U.S. Cl. 345/156

(57) ABSTRACT

A method and system for activating a graphical user interface (GUI) or controlling a device with gesture commands via a laser beam. The method includes detecting, by a laser beam detector, a laser beam on a screen and then determining, by a laser beam processing module, a position of the laser beam on the screen. The laser beam processing module then determines whether the position coordinates with a selection on a graphical user interface (GUI) displayed on the screen, or by tracking the laser beam that a gesture command is to be executed.

### BACKGROUND

The importance for the consumer electronic device industry to continuously strive to produce devices that are convenient to use cannot be overstated. No doubt this is one of the reasons for making devices that contain more storage capacity, more processing capacity, and offer more user options. For example, the functionality of one or more devices such as digital televisions, digital video disk (DVD) players, video cassette recorder (VCR) players, compact disk (CD) players, set-top boxes, stereo receivers, media centers, personal video recorders (PVR), and so forth, may be combined into one device having combined functionality.

Convenience of use for such a device having combined functionality may decrease if the graphical user interface (GUI) for that device contains too many selections to conveniently use with a typical remote control. For example, a typical remote control used today for interactive televisions have a number of color coded buttons to navigate and select among many options. Due to the limited ability to navigate and select, many button pushes are often required and/or multiple screens are presented to the user. The many button pushes and/or multiple screens are often too much information for the user to remember over time. An additional constraint of the typical remote control is the so called “10-foot” user interface to the remote user interface.

### BRIEF DESCRIPTION OF THE DRAWINGS

The invention may be best understood by referring to the following description and accompanying drawings that are used to illustrate embodiments of the invention. In the drawings:

FIG. 1 illustrates one example of a graphical user interface (GUI) that may be utilized by the present invention;

FIG. 2 illustrates one embodiment of an environment for activating a GUI in a rear projection device via a laser beam, in which some embodiments of the present invention may operate;

FIG. 3 illustrates another embodiment of an environment for activating a GUI in a front projection device via a laser beam, in which some embodiments of the present invention may operate;

FIGS. 4A and 4B illustrate a flow diagram of one embodiment of a process for the operation of activating a GUI via a laser beam;

FIG. 5 illustrates one example of a GUI that may be utilized by the present invention;

FIG. 6 illustrates an example of a gesture command that may be utilized by the present invention; and

FIGS. 7A and 7B illustrate a flow diagram of one embodiment of a process for the operation of activating a GUI via a gesture command drawn on a screen.

### DESCRIPTION OF EMBODIMENTS

A method and system for activating a graphical user interface (GUI) via a laser beam are described. Here, at least some of the problems described above with devices having increased funcationality may be alievated by allowing a user to interact with a GUI displayed on a screen of such a device by using a laser beam to activate the GUI. In an embodiment of the invention, a laser pointer may be incorporated into the remote control of the device. In the following description, for purposes of explanation, numerous specific details are set forth. It will be apparent, however, to one skilled in the art that embodiments of the invention can be practiced without these specific details.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

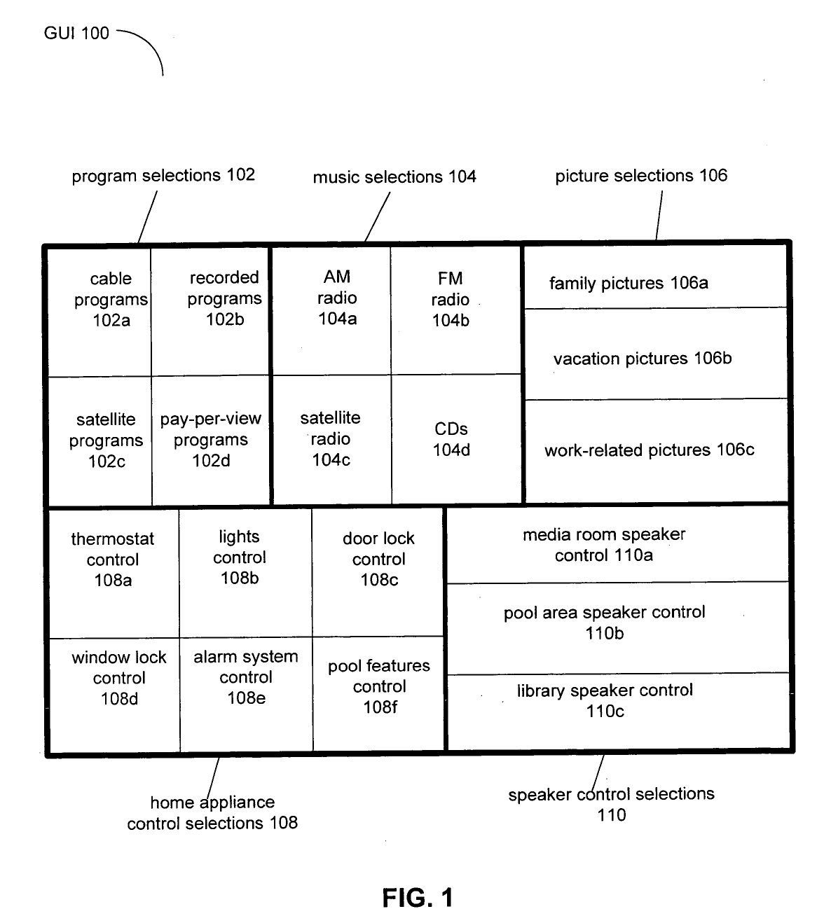

FIG. 1 illustrates one example of a graphical user interface (GUI) 100 that may be utilized by the present invention to interact with a device. The example GUI shown in FIG. 1 is provided for illustration purposes only and is not meant to limit the invention. As one skilled in the art will appreciate, a GUI is typically a program interface that takes advantage of a computer's graphics capabilities to make a device easier to interact with.

The example GUI 100 shown in FIG. 1 may be used with a device that combines the functionality of one or more of a digital television, a DVD player, a VCR player, a CD player, a set-top box, a stereo receiver, a media center, a PVR, home applicance controllers, a MP3 player, and so forth. As shown in FIG. 1, GUI 100 may provide one or more of the following types of selections to a user: program selections 102, music selections 104, picture selections 106, home appliance control selections 108 and speaker control selections 110.

For example, via program selections 102, the user may select to view his or her options regarding cable programs 102a, recorded programs 102b, satellite programs 102c and pay-per-view programs 102d. Via music selections 104, the user may select from AM radio 104a, FM radio 104b, satellite radio 104c and CDs 104d. The user, via picture selections 106, may view family pictures 106a, vacation pictures 106b and work-related pictures 106c. Via home appliance control selections 108, the user may control his or her thermostat via thermostat control 108a, turn on or off the building lights via lights control 108b, lock or unlock the doors via door lock control 108c, lock or under the windows via window lock control 108d, control the alarm system via alarm system control 108e and control the pool features via control 108f. Audio may also be controlled by the user via speaker control selections 110 and may include media room speaker control 110a, pool area speaker control 110b and library speaker control 110c. In an embodiment of the invention, GUI 100 may also include a “back” option or “abort” option that the user may activate to go back to the previous GUI (if applicable).

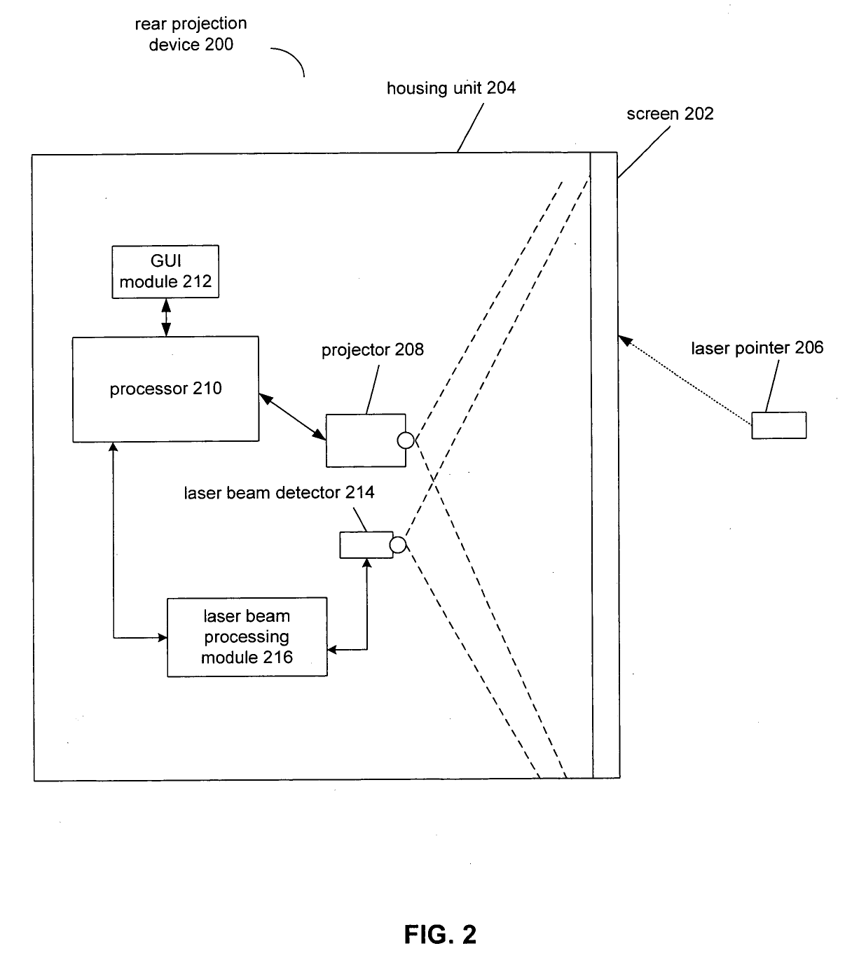

FIG. 2 illustrates one embodiment of an environment for activating a GUI in a rear projection device 200 via a laser beam, in which some embodiments of the present invention may operate. The specific components shown in FIG. 2 represent one example of a configuration that may be suitable for the invention and is not meant to limit the invention.

Referring to FIG. 2, rear projection device 200 is shown. In an embodiment of the invention, rear projection device 200 may be a device that incorporates the functionality of one or more of a digital television, a DVD player, a VCR player, a CD player, a set-top box, a stereo receiver, a media center, a PVR, home applicance controls, digital picture storage, MP3 player, and so forth. Rear projection device 200 may include, but is not necessarily limited to, a screen 202 and a housing unit 204. A laser pointer 206 may be used to activate and interact with a GUI associated with screen 202.

In an embodiment of the invention, housing unit 204 may house a projector 208, a processor 210, a GUI module 212, a laser beam detector 214 and a laser beam processing module 216. Other embodiments of the invention may include more or less components as described in FIG. 2. For example, the functionality of two or more components of FIG. 2 may be combined into one component. Likewise, the functionality of one component of FIG. 2 may be separated and performed by more than one component. Each component shown in FIG. 2 may be implemented as a hardware element, as a software element executed by a processor, as a silicon chip encoded to perform its functionality described herein, or any combination thereof. The components shown in FIG. 2 are described next in more detail.

At a high level and in an embodiment of the invention, laser beam detector 214 detects a laser beam directed at screen 202. Laser beam detector 214 is directed at the back of screen 202 and detects the laser beam as it goes through screen 202. Once a laser beam is detected, laser beam detector 214 waits for a period of time and continues to scan screen 202 to ensure that the user is actually trying to interact with the GUI displayed on screen 202. Laser beam processing module 216 then calculates the position of the laser beam on screen 202. If module 216 can determine the position of the laser beam on screen 202, then the position of the laser beam is sent to processor 210 and GUI module 212 to process the selection or interaction with the GUI in a normal fashion.

Screen 202 may display a GUI, such as GUI 100 of FIG. 1. The present invention is described with reference to GUI 100. This is not meant to limit the invention and is provided only for illustration purposes. GUI 100 displayed on screen 202 may be activated by a laser beam from laser pointer 206. For example, if the user is viewing GUI 100 and wants to view his or her family pictures, then the user could point laser pointer 206 at family pictures 106a of GUI 100.

In an embodiment of the invention, laser pointer 206 may be a typical laser pointer that is well known in the art. In another embodiment, laser pointer 206 may represent a remote control that incorporates laser beam technology. In this embodiment, the remote control with laser beam technology may also incorporate typical remote control buttons and/or functionality. For example, one or more control buttons on the remote control may be implemented as a hard button or switch. One or more control buttons on the remote control may also be implemented as a soft button, for example, implemented via a liquid crystal display (LCD) touch screen on the remote control. These example implementations and/or functions of laser pointer 206 are provided as illustrations only and are not meant to limit the invention.

In an embodiment of the invention, projector 208 may be a typical projector that is well known in the art and used for rear projection televisions. Projector 208 may display objects on screen 202 as directed by processor 210. Processor 210 interacts with GUI module 212 to display one or more GUIs on screen 202 to use when interacting with rear projection device 200.

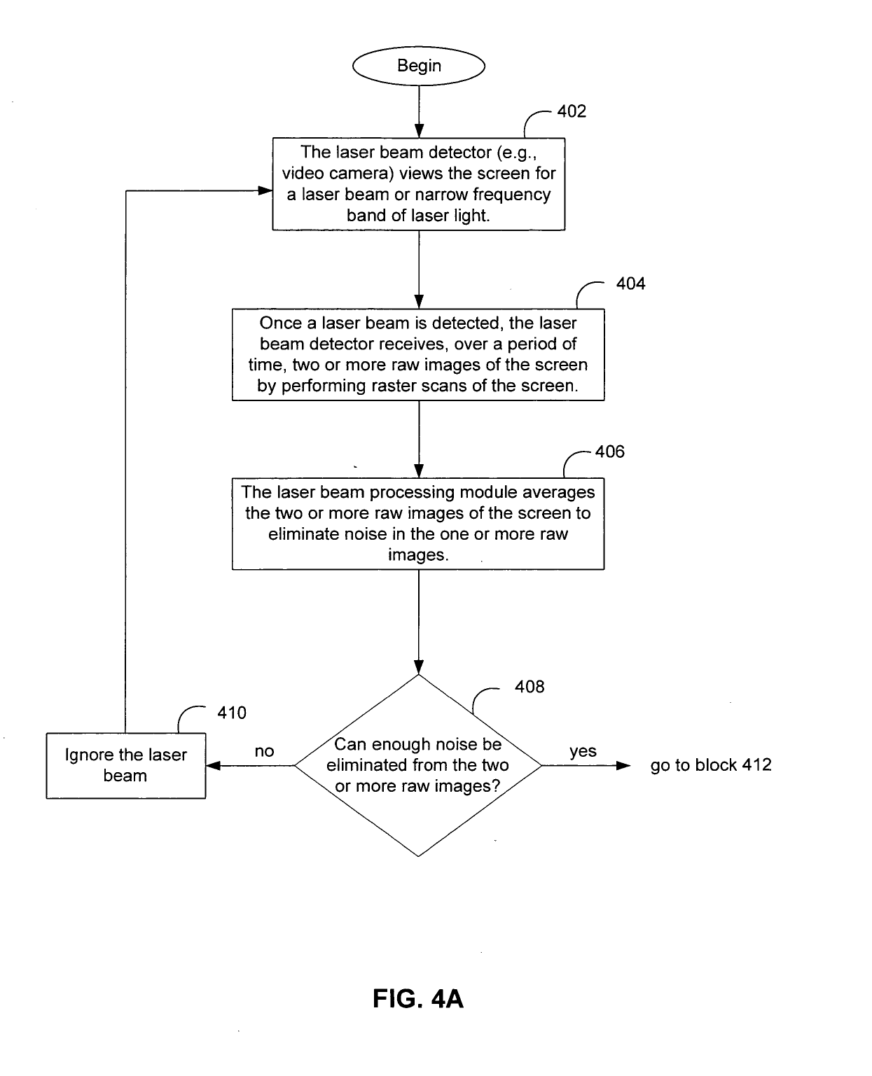

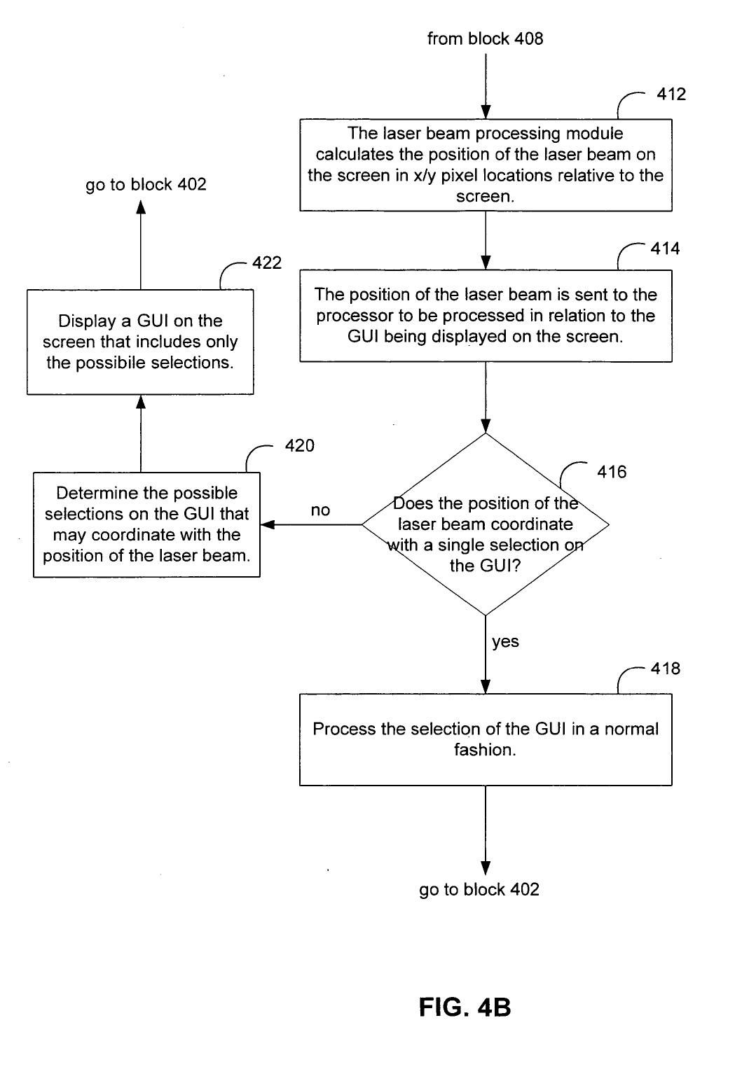

Laser beam detector 214 detects a laser beam from the rear of screen 202 as the laser beam is projected onto screen 202 via laser pointer 206. In an embodiment of the invention, laser beam detector 214 may be a video camera that views screen 202 and measures the narrow frequency band of laser light in a raster scan over screen 202. In an embodiment of the invention, laser beam detector 214 is mounted inside of device 200 to get the best view of screen 202. Detector 214 may also be off-axis to projector 208 and the raw images captured by detector 214 may be warped through graphic transforms to account for the warping effect of laser beam detector 214 being off-axis. In an embodiment of the invention, the position of the laser beam is measured in x/y pixel locations relative to screen 202 and is processed by laser beam processing module 216 as is described in more detail with reference to FIGS. 4A and 4B below.

In another embodiment of the invention, laser beam detector 214 may also be embedded in screen 202 and implemented as a photo sensor (e.g., photo diode or photo transistor array). Here, screen 202 may be a LCD or Plasma screen. The photo sensor may be “deposited” onto the screen directly and the x/y position of the laser beam may be detected by virtue of the array itself.

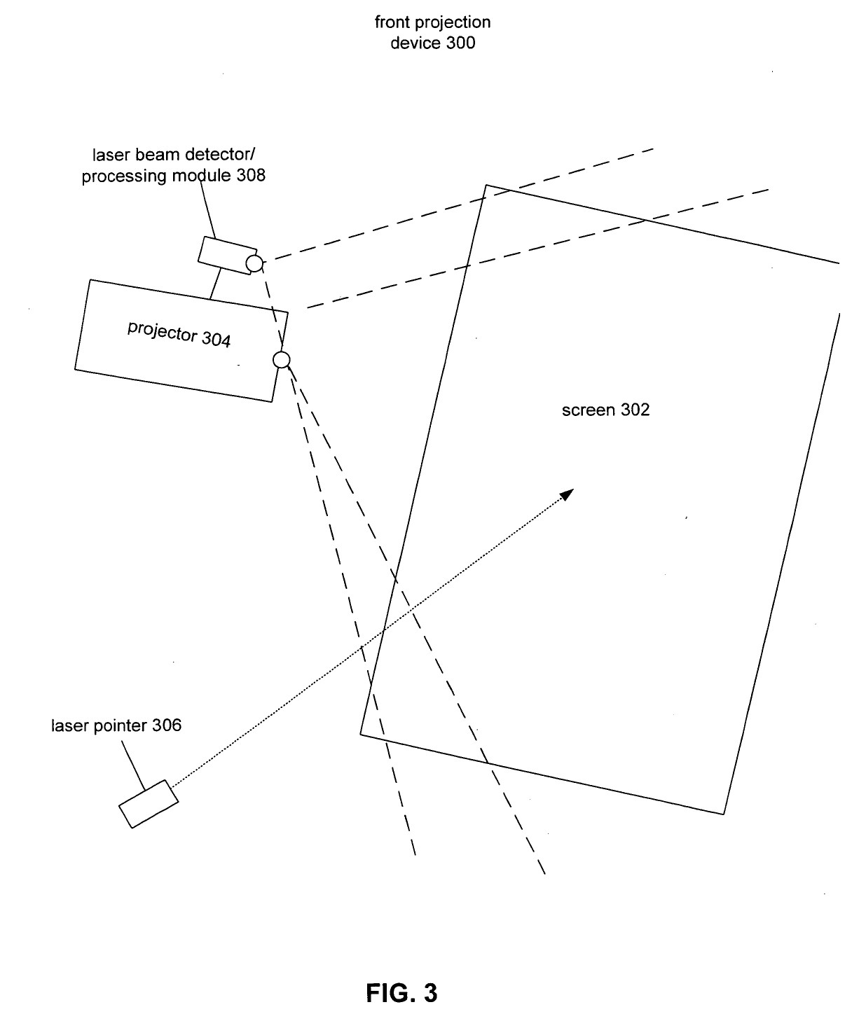

FIG. 3 illustrates another embodiment of an environment for activating a GUI of a front projetion device 300 via a laser beam, in which some embodiments of the present invention may operate. The specific components shown in FIG. 3 represent one example of a configuration that may be suitable for the invention and is not meant to limit the invention. The components in FIG. 3 may be connected via wired or wireless connections.

Referring to FIG. 3, front projection device 300 is shown. In an embodiment of the invention, front projection device 300 may be a device that incorporates the functionality of one or more of a digital television, a DVD player, a VCR player, a CD player, a set-top box, a stereo receiver, a media center, a PVR, home applicance controls, digital picture storage, MP3 player, and so forth. Front projection device 300 may include, but is not necessarily limited to, a screen 302, a projector 304 and a laser beam detector/processing module 308. A laser pointer 306 may be used to activate and interact with a GUI associated with screen 302. In an embodiment of the invention, laser beam detector/processing module 308 is mounted on projector 304. Other embodiments of the invention may include more or less components as described in FIG. 3. Each component shown in FIG. 3 may be implemented as a hardware element, as a software element executed by a processor, as a silicon chip encoded to perform its functionality described herein, or any combination thereof. The components shown in FIG. 3 are described next in more detail.

At a high level and in an embodiment of the invention, laser beam detector/processing module 308 detects a laser beam directed at screen 302. Laser beam detector/processing module 308 is directed at the front of screen 302 and detects the laser beam as it is reflected off of screen 302. Once a laser beam is detected, laser beam detector/processing module 308 waits for a period of time and continues to scan screen 302 to ensure that the user is actually trying to interact with the GUI displayed on screen 302. Laser beam detector/processing module 308 then calculates the position of the laser beam on screen 302. If module 308 can determine the position of the laser beam on screen 302, then the position of the laser beam is sent to projector 304 to process the selection or interaction with the GUI in a normal fashion.

As with screen 202 of FIG. 2, screen 302 may display a GUI, such as GUI 100 of FIG. 1. The GUI displayed on screen 302 may be activated by a laser beam from laser pointer 306. In an embodiment of the invention, laser pointer 306 is similar to laser pointer 206 as described above with reference to FIG. 2. In an embodiment of the invention, projector 304 may be a typical projector that is well known in the art and used for front projection televisions. In an embodiment of the invention, projector 304 may include all of the functionalities of projector 208, processor 210 and GUI module 212 described above with reference to FIG. 2.

In an embodiment of the invention, laser beam detector/processing module 308 may include all of the functionality as laser beam detector 214 and laser beam processing module 216 as described above. In an embodiment of the invention, laser beam detector/processing module 308 may be a video camera that is mounted to projector 304 to get the best view of screen 302. Laser beam detector/processing module 308 may also be off-axis to projector 304 and the raw images captured may be warped through graphic transforms to account for the warping effect of laser beam detector/processing module 308 being off-axis. Laser beam detector/processing module 308 may also be embedded in screen 202 and implemented as a photo sensor, as described above with reference to laser beam detector 214.

Operations for the above components described in FIGS. 2 and 3 may be further described with reference to the following figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

FIGS. 4A and 4B illustrate a flow diagram of one embodiment of a process for the operation of activating a GUI associated with either a front or rear projection device via a laser beam. Referring to FIG. 4A, the process begins at processing block 402 where a laser beam detector (such as laser beam detector 214 in FIG. 2 or laser beam detector/processing module 308 in FIG. 3) views a screen (such as screen 202 or screen 302 in FIGS. 2 and 3, respectively) for a laser event or beam. In an embodiment of the invention, the laser beam is a narrow frequency band of laser light.

In processing block 404, once a laser beam is detected the laser beam detector receives two or more raw images of the screen by performing raster scans of the screen. The two or more raw images are received over a period of time to ensure that the user is actually trying to interact with the GUI displayed on the screen. The laser beam processing module (such as module 216 in FIG. 2 or module 308 in FIG. 3) averages the two or more raw images to eliminate noise in the images at processing block 406. The user directing the laser beam at the screen may have a shaky hand, in this type of system this is considered “noise”. One possible result of a shaky hand is that the laser beam hits a series of positions on the screen. Here, the laser beam processing module may average the raw images and determine that the user has hit a particular position on the screen more than any other position.

At decision block 408, if enough noise can be eliminated from the raw images (i.e., the laser beam processing module can determine one consistent position on the screen) then the process continues at block 412 in FIG. 4B. Otherwise, the process continues at block 410 where the laser beam is ignored. The process goes back to processing block 402 where the laser beam detector views the screen for the next laser beam.

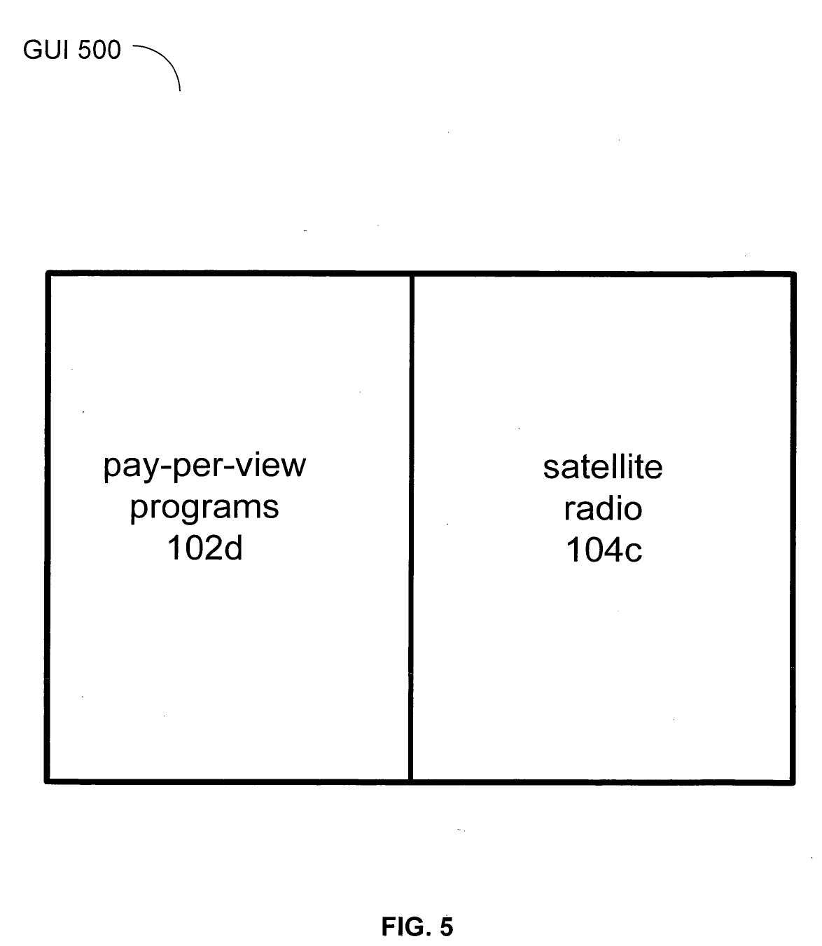

At processing block 412 in FIG. 4B, the laser beam processing module calculates the position of the laser beam on the screen in x/y pixel locations relative to the screen. The position of the laser beam is then sent to the processor (such as processor 210 of FIG. 2 and the processor incorporated into projector 304 in FIG. 3) at processing block 414. Here, the processor determines whether the position of the laser beam coordinates with a single selection or command of the GUI displayed on the screen. If the position of the laser beam coordinates with a single selection on the GUI in decision block 416, then the selection of the GUI is processed in a normal fashion well known to those skilled in the art. Otherwise, the possible selections on the GUTI that may coordinate with the position of the laser beam are determined in processing block 420. For example, assume that with GUI 100 of FIG. 1 the possible selections are determined to be pay-per-view programs 102d and satellite radio 104c. In an embodiment of the invention, a new GUI 500 in FIG. 5 may be displayed on the screen. Here, the possible selections are enlarged so that it is easier for the user to select one or the other with the laser beam. In an embodiment of the invention, GUI 500 may also include a “back” option or “abort” option that the user may activate to go back to the previous GUI. The process then continues at block 402 (FIG. 4A) where the laser beam detector views the screen for the laser beam from the user.

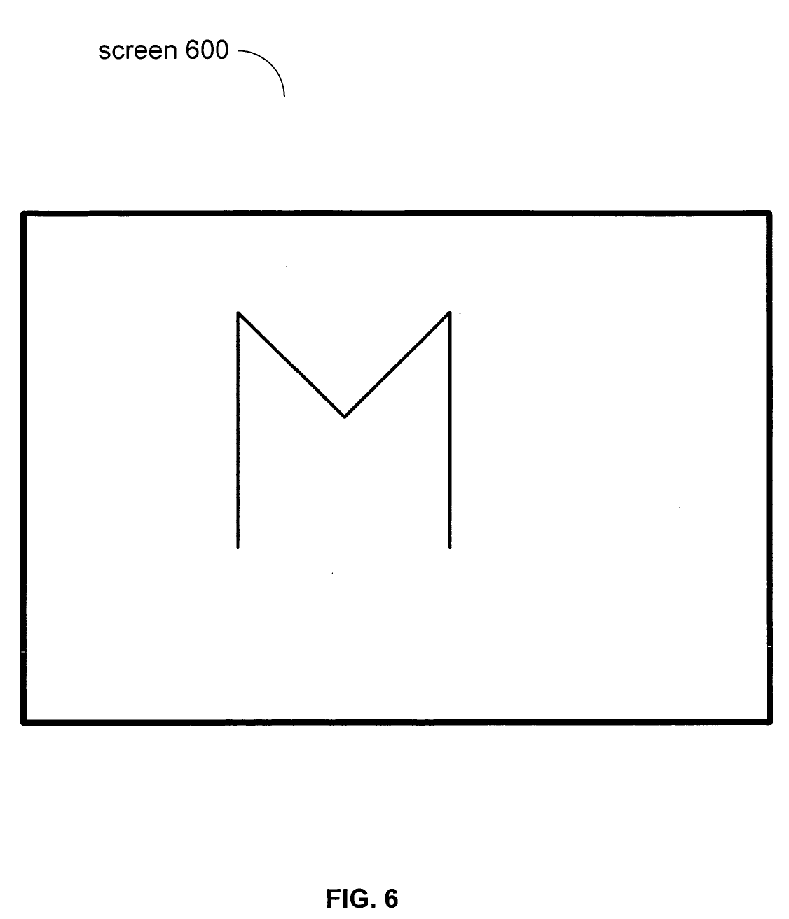

FIG. 6 illustrates an example of a gesture command that may be utilized by the present invention. Here, the user may use the laser pointer to make a simple gesture on screen 600 of either a rear projection device or a front projection device when a GUI is not active on the screen. For example, as shown in FIG. 6, the user may trace the letter “M” on the screen with the laser pointer. In an embodiment of the invention, “M” may be defined as a menu gesture command that activates a GUI on the screen with a main menu. In another possible example, the trace of the letter “O” may correspond to an off command where the device is turned off. There are a limitless number of gesture commands that may be defined and utilized by the present invention and these illustrations are not meant to limit the invention.

In an embodiment of the invention, laser pointers 206 and 306 (FIGS. 2 and 3, respectively) may represent a remote control that incorporates laser beam technology and has a single button. The single button on the remote control may be used to activate the laser and turn on a device (e.g., rear projection device 200 from FIG. 2 or front projection device 300 from FIG. 3). The user may then use gesture commands via the laser beam to activate all other commands with the device.

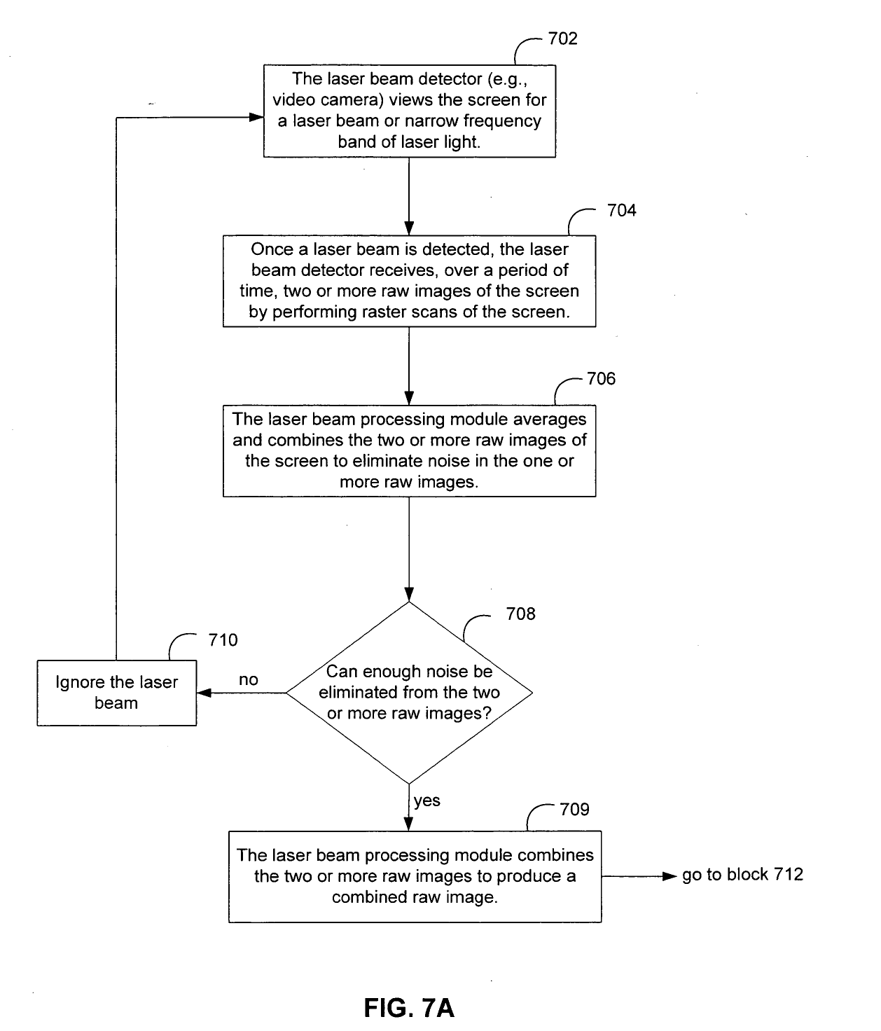

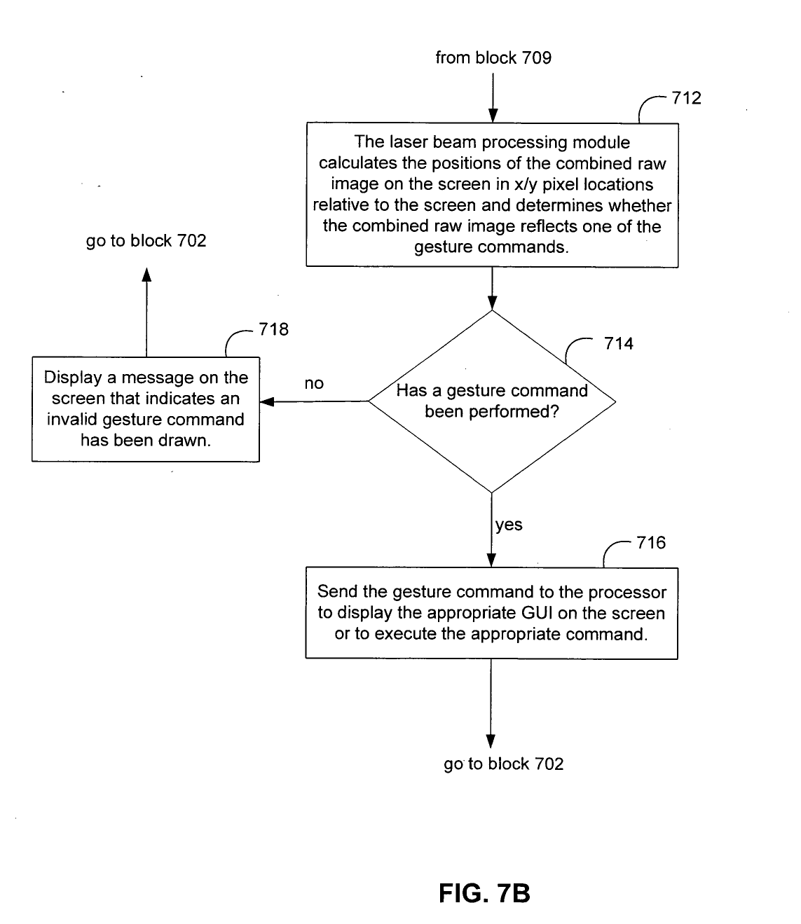

FIGS. 7A and 7B illustrate a flow diagram of one embodiment of a process for the operation of activating a GUI or other command via a gesture command drawn on a screen with a laser beam. Referring to FIG. 7A, the process begins at processing block 702 where a laser beam detector (such as laser beam detector 214 in FIG. 2 or laser beam detector/processing module 308 in FIG. 3) views a screen (such as screen 202 or screen 302 in FIGS. 2 and 3, respectively) for a laser event or beam.

In processing block 704, once a laser beam is detected the laser beam detector receives two or more raw images of the screen by performing raster scans of the screen. The two or more raw images are received over a period of time to ensure that the user is actually trying to interact with the screen and to capture enough raw images to combine the laser beams to create a gesture command. The laser beam processing module (such as module 216 in FIG. 2 or module 308 in FIG. 3) averages the two or more raw images to eliminate noise in the images at processing block 706. The user directing the laser beam at the screen may have a shaky hand. One possible result of a shaky hand is that the laser beam hits a series of positions on the screen. Here, the laser beam processing module may average the raw images and determine that the user has hit particular position(s) on the screen more than other position(s).

At decision block 708, if enough noise can be eliminated from the raw images (i.e., the laser beam processing module can determine position(s) on the screen) then the process continues at block 709. Otherwise, the process continues at block 710 where the laser beam is ignored. The process goes back to processing block 702 where the laser beam detector views the screen for the next laser beam.

At processing block 709, the laser beam processing module combines the two or more raw images to produce a combined raw image. At processing block 712 in FIG. 7B, the laser beam processing module calculates the positions of the combined raw image on the screen in x/y pixel locations relative to the screen. It is then determined whether the combined raw image reflects one of the gesture commands defined by the invention.

If a gesture command has been performed in decision block 714, then the gesture command is sent to the processor to display the appropriate GUI on the screen or to execute the appropriate command at processing block 716. Otherwise, at processing block 718, a message is displayed on the screen that informs the user that an invalid gesture command has been drawn on the screen. In either event, the process then continues at block 702 (FIG. 7A) where the laser beam detector views the screen for the next laser beam from the user.

In an embodiment of the invention, the screen of a device may be divided into two areas. One area of the screen is used to display an active GUI and the other area is used for gesture commands. Here, one laser beam detector scans the area with the active GUI for a laser beam and a second laser beam detector scans the area of the screen used for gesture commands for a laser beam. The side of the screen used for the active GUI is processed according to FIGS. 4A and 4B as described above. The side of the screen used for gesture commands is processed according to FIGS. 7A and 7B as described above.

Embodiments of the present invention may be implemented in software, firmware, hardware or by any combination of various techniques. For example, in some embodiments, the present invention may be provided as a computer program product or software which may include a machine or computer-readable medium having stored thereon instructions which may be used to program a computer (or other electronic devices) to perform a process according to the present invention. In other embodiments, steps of the present invention might be performed by specific hardware components that contain hardwired logic for performing the steps, or by any combination of programmed computer components and custom hardware components.

Thus, a machine-readable medium may include any mechanism for storing or transmitting information in a form readable by a machine (e.g., a computer). These mechanisms include, but are not limited to, a hard disk, floppy diskettes, optical disks, Compact Disc, Read-Only Memory (CD-ROMs), magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

Some portions of the detailed descriptions above are presented in terms of algorithms and symbolic representations of operations on data bits within a computer system's registers or memory. These algorithmic descriptions and representations are the means used by those skilled in the data processing arts to convey the substance of their work to others skilled in the art most effectively. An algorithm is here, and generally, conceived to be a self-consistent sequence of operations leading to a desired result. The operations are those requiring physical manipulations of physical quantities. Usually, although not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussions, it is appreciated that discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A system comprising:
a laser beam detector; and
a laser beam processing module, wherein the laser beam detector is capable of detecting a laser beam on a screen, and wherein the laser beam processing module is capable of determining a position of the laser beam on the screen, and wherein the laser beam processing module is capable of determining whether the position coordinates with a selection on a graphical user interface (GUI) displayed on the screen.

2. The system of claim 1, wherein the screen is part of a projection device.

3. The system of claim 2, wherein the projection device is a rear projection device.

4. The system of claim 2, wherein the projection device is a front projection device.

5. The system of claim 1, wherein the laser beam is generated by a laser pointer.

6. The system of claim 5, wherein the laser pointer is incorporated into a remote control.

7. The system of claim 1, wherein the position of the laser beam on the screen is calculated in x/y pixel locations relative to the screen.

8. The system of claim 1, wherein if the position coordinates with two or more selections on the GUI then determining a new GUI to be displayed on the screen that includes only the two or more selections.

9. The system of claim 8, wherein the new GUI to be displayed on the screen also includes a “back” selection.

10. The system of claim 1, wherein the laser beam detector is a video camera.

11. The system of claim 1, wherein the laser beam detector is a photo sensor that is embedded into the screen.

12. A system comprising:
a laser beam detector; and
a laser beam processing module, wherein the laser beam detector is capable of detecting a laser beam on a screen, wherein the laser beam processing module is capable of determining one or more positions of the laser beam on the screen over a period of time, and wherein the laser beam processing module is capable of determining whether the one or more positions of the laser beam on the screen indicate a gesture command.

13. The system of claim 12, wherein the screen is part of a projection device.

14. The system of claim 13, wherein the projection device is a rear projection device.

15. The system of claim 13, wherein the projection device is a front projection device.

16. The system of claim 12, wherein the laser beam is generated by a laser pointer.

17. The system of claim 16, wherein the laser pointer is incorporated into a remote control.

18. The system of claim 17, wherein the remote control has a single button to activate the laser pointer.

19. The system of claim 12, wherein the one or more positions of the laser beam on the screen are calculated in x/y pixel locations relative to the screen.

20. The system of claim 12, wherein the laser beam detector is a video camera.

21. The system of claim 12, wherein the laser beam detector is a photo sensor that is embedded into the screen.

22. A method comprising:
detecting, by a laser beam detector, a laser beam on a screen;
determining, by a laser beam processing module, a position of the laser beam on the screen; and
determining, by the laser beam processing module, whether the position coordinates with a selection on a graphical user interface (GUI) displayed on the screen.

23. The method of claim 22, wherein the screen is part of a front projection device.

24. The method of claim 22, wherein the screen is part of a rear projection device.

25. The method of claim 22, wherein the laser beam is generated by a laser pointer.

26. The method of claim 25, wherein the laser pointer is incorporated into a remote control.

27. The method of claim 22, wherein if the position coordinates with two or more selections on the GUI then determining a new GUI to be displayed on the screen that includes only the two or more selections.

28. The method of claim 27, wherein the new GUI to be displayed on the screen also includes a “back” selection.

29. The method of claim 22, wherein the laser beam detector is a video camera.

30. The method of claim 22, wherein the laser beam detector is a photo sensor that is embedded into the screen.

31. A method comprising:
detecting, by a laser beam detector, a laser beam on a screen;
determining, by a laser beam processing module, one or more positions of the laser beam on the screen over a period of time; and
determining, by the laser beam processing module, whether the one or more positions of the laser beam on the screen indicate a gesture command.

32. The method of claim 31, wherein the screen is part of a front projection device.

33. The method of claim 31, wherein the screen is part of a rear projection device.

34. The method of claim 31, wherein the laser beam is generated by a laser pointer.

35. The method of claim 34, wherein the laser pointer is incorporated into a remote control.

36. The method of claim 34, wherein the remote control has a single button to activate the laser pointer.

37. The method of claim 31, wherein the laser beam detector is a video camera.

38. The method of claim 31, wherein the laser beam detector is a photo sensor that is embedded into the screen.
